(19) United States
(12) Patent Application Publication
(10) Pub. No.: US 2013/0146566 A1
(43) Pub. Date: Jun. 13, 2013

(54) METHOD AND SYSTEM TO LASER HOT WIRE LAYER A PIPE END

(71) Applicant: LINCOLN GLOBAL, INC., City of Industry, CA (US)

(72) Inventors: Steven R. Peters, Huntsburg, OH (US); Paul E. Denney, Bay Village, OH (US)

(73) Assignee: LINCOLN GLOBAL, INC., City of Industry, CA (US)

(21) Appl. No.: 13/757,162

(22) Filed: Feb. 1, 2013

Related U.S. Application Data
(63) Continuation-in-part of application No. 13/212,025, filed on Aug. 17, 2011.
Application No. 13/212,025 is a continuation-in-part of application No. 12/352,667, filed on Jan. 13, 2009.

(51) Int. Cl. B23K 9/04

(52) U.S. Cl. CPC B23K 9/04
USPC 219/61; 219/60 R

(57) ABSTRACT

A system and method to clad a surface of a pipe using a high intensity energy source and a hot wire consumable, where the hot wire consumable is heated to a temperature sufficient to melt the consumable in a molten puddle while preventing the creation of an arc between the consumable and the puddle.

### PRIORITY CLAIM

The present application is a continuation-in-part of U.S. patent application Ser. No. 13/212,025, filed on Aug. 17, 2011, which is a continuation-in-part of U.S. patent application Ser. No. 12/352,667, filed on Jan. 13, 2009, both of which are incorporated herein by reference in their entirety.

### TECHNICAL FIELD

This invention relates to a systems and methods for hot wire processing. More specifically, the subject invention relates to systems and methods for orbital hot wire cladding.

### BACKGROUND

In a typical laser hot wire or filler wire process between a wire and workpiece, a laser heats and melts a workpiece to form a molten puddle. A filler wire is advanced towards a workpiece and the molten puddle. The wire is resistance-heated by a separate energy source such that the wire approaches or reaches its melting point and contacts the molten puddle. The heated wire is fed into the molten puddle for carrying out the hot wire process. Accordingly, transfer of the filler wire to the workpiece occurs by simply melting the filler wire into the molten puddle.

In the case of joining pipe members of dissimilar materials it is sometimes desirable to clad or apply a layer of metal alloy material, such as for example, a nickel alloy at the pipe ends to act as an intermediate or “butter” layer at the pipe ends before they are welded together. Moreover, it is generally desirable to minimize the admixture between the layer and the material of the pipes. Accordingly, it generally desired to minimize the thickness of the intermediate layer.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention include an orbital hot wire system for carrying out a hot wire process about the exterior of a pipe end. The system includes a torch assembly having a laser optics subassembly and a contact tube subassembly. A track is configured for mounting to the end portion of a pipe. A carriage is secured to the track for orbital translation about the pipe end portion. The torch assembly is coupled to the carriage for rotation of the torch assembly about the pipe end portion. A controller is provided for process control of the torch assembly so as to provide for a hot wire process over an angular translation about the pipe P, the angular translation defining an angle of about 180 degrees. Embodiments of the present invention can also include a control system providing for a hot wire process over an angular translation about the pipe P, the angular translation defining an angle in the range of 180 to 360 degrees.

Another embodiment provides a torch assembly for orbital hot wire processing about a pipe end. The torch assembly includes a laser optics subassembly for providing a laser beam to the pipe surface and a contact tube subassembly for delivering a filler wire W to the pipe surface proximate the laser beam. The laser optics subassembly has a distal end from which the focused laser beam emits and the contact tube assembly includes a distal end from which the filler wire extends. The distal ends of the laser optics subassembly and contact tube assembly defining a minimum clearance distance C therebetween.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1A is a perspective illustrative embodiment of an orbital hot wire processing system;

FIG. 1B is a side view of the system of FIG. 1A;

FIG. 1C is a schematic view of a laser optics subassembly for use in the system of FIG. 1A;

FIG. 2 is a schematic end view of the torch assembly of FIG. 1A about pipe P;

FIG. 2A is a schematic end view of an alternative embodiment of a torch assembly for use in the system of FIG. 1A.

FIG. 2B is a schematic end view of the torch assembly shown in FIG. 2;

FIG. 3 is a schematic view of a centralized control system used in the system of FIG. 1A;

FIG. 4 is an isometric view of an alternate embodiment of the system of FIG. 1A; and

FIG. 5 is a schematic view of another exemplary embodiment of the present invention.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

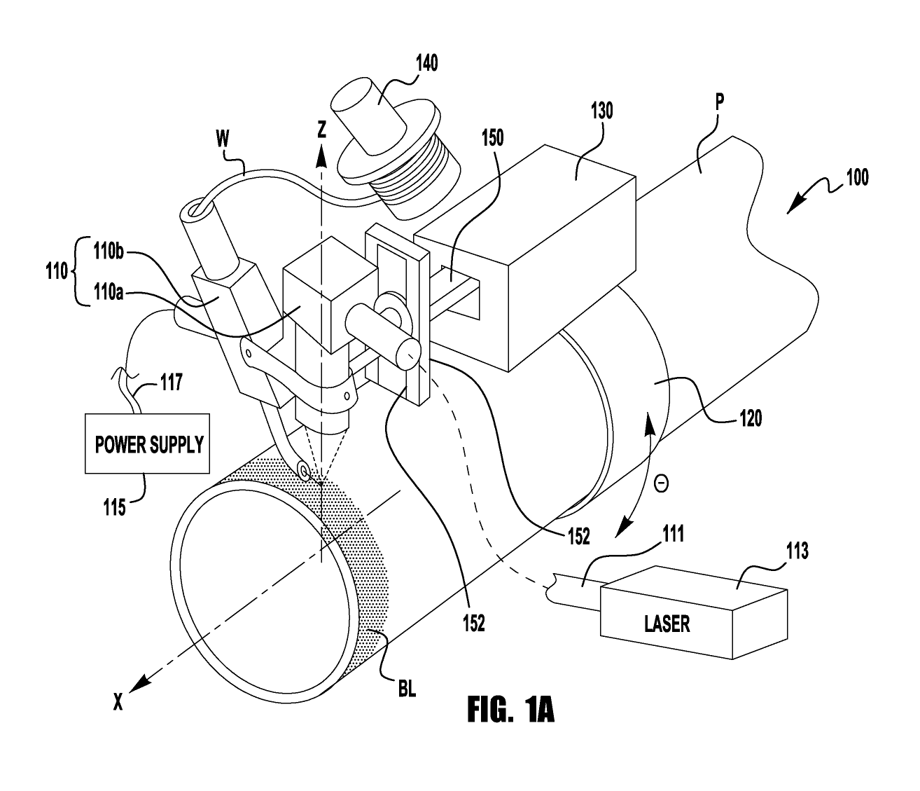

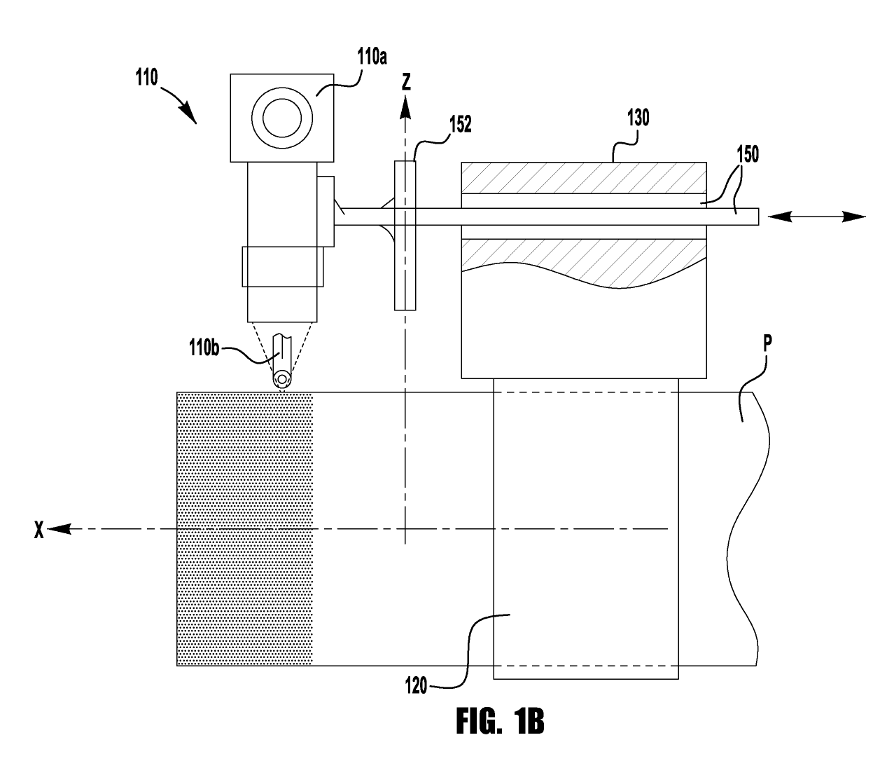

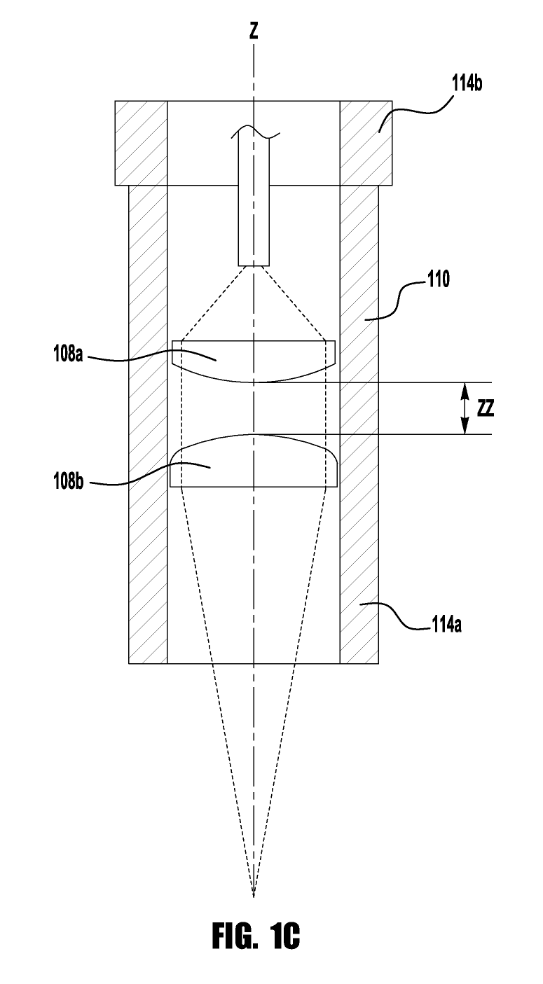

FIG. 1 is an illustrative embodiment of a system 100 for cladding an end of a pipe P in a hot wire process. Generally, the system includes a torch assembly having a laser in combination with a contact tube, in which the assembly is rotated about a pipe end to clad the end portion of the pipe P in a hot wire process. More specifically, the system 100 includes a torch assembly 110 for carrying out a hot wire process to apply a layer of material, and more particularly a “butter” layer BL at end portion of the pipe P. One exemplary material applied to the pipe is a nickel alloy, such as for example, Techalloy 625 which may be used to facilitate adjoining the pipe P to another pipe or pipe fitting of a dissimilar material. The torch assembly 110 includes a laser optics subassembly 110a for applying a laser beam to the pipe end portion to form/maintain a molten puddle and a contact tube subassembly 110b for delivery of a filler wire W to the molten puddle in a hot wire cladding process described, for example, in U.S. Patent Publication No. 2010/0176109, which is incorporated by reference in its entirety.

The torch assembly 110 is coupled to an orbital subsystem for circumferentially translating the torch assembly 110 about the pipe end portion. More specifically, the orbital subsystem includes a track 120 that extends circumferentially about the track 120. The track 120 is located along the axial length of the pipe P so as to locate the torch assembly 110 at the end of the pipe. Secured to the track 120 is a carriage 130 secured for orbital translation about the pipe P. An exemplary track and self-propelled carriage is shown and described in U.S. Pat. No. 5,227,601, which is incorporated by reference in its entirety.

The carriage 130 is shown in one aspect as including a wire feeder 140 that rotates about the pipe P with the torch assembly 110 to feed filler wire to the contact tube 110b. An exemplary wire feeder mounted to an orbital carriage is also shown and described in U.S. Pat. No. 5,227,601. Another exemplary orbital carriage and track arrangements is provided in the Helix T55 Orbital Welder from The Lincoln Electric Company of Cleveland, Ohio. The wire feeder 140, in one aspect, includes a hub (not shown) for supporting the spool of filler wire W and a feed mechanism (not shown) to pull and feed the wire W to the contact tube 110b. An exemplary wire feeder 140 includes a motor that is configured for hot wire process control by a system controller in a manner described below. Alternatively, the wire feeder 140 may be a non-rotating feeder and separate from the carriage 130. The separate wire feeder is located and configured to provide payout of the wire from the feeder 140 does not interfere with the orbital translation of the torch assembly 110 as described in greater detail below.

The torch assembly 110 is adjustably coupled to the carriage 130 for locating the torch assembly 110 relative to the track carriage 130. For example, the system 100 includes a mechanism for adjusting the axial location of the torch assembly 110 along the pipe axis X-X relative to the carriage 130 and more particular relative to the end of the pipe P. As seen for example in FIG. 1B, the torch assembly 110 may be coupled to the carriage 130 by an adjustment arm 150. Moreover, the adjustment arm 150 may further be engaged with a slide mechanism (not shown) housed within the carriage 130 for positioning the torch in the X axis and oscillation of the torch 110 back and forth along the X-X axis. An exemplary adjustment and oscillating arrangement is shown and described in U.S. Pat. No. 5,227,601. The oscillating adjustment arm 150 and its axial oscillation can define the width of the cladding layer BL in the X-X direction. Accordingly, in one embodiment, the oscillating is configured for process control by a centralized controller in manner described in greater detailed below.

The system 100 in one aspect may be configured for radial adjustment of the torch assembly 110 relative to the outer surface of the pipe P. For example, the system may include a second adjustment mechanism such as an adjustable bracket 152 configured for radially locating the torch assembly 110 along the radial axis Z-Z along which a laser beam extends and relative to the outer surface of the pipe P.

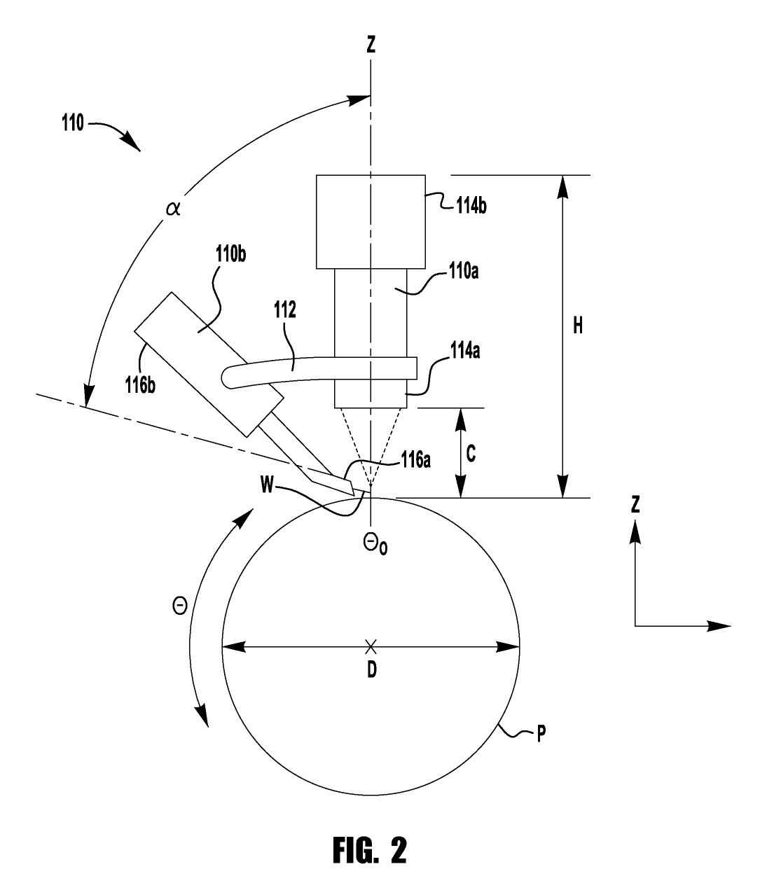

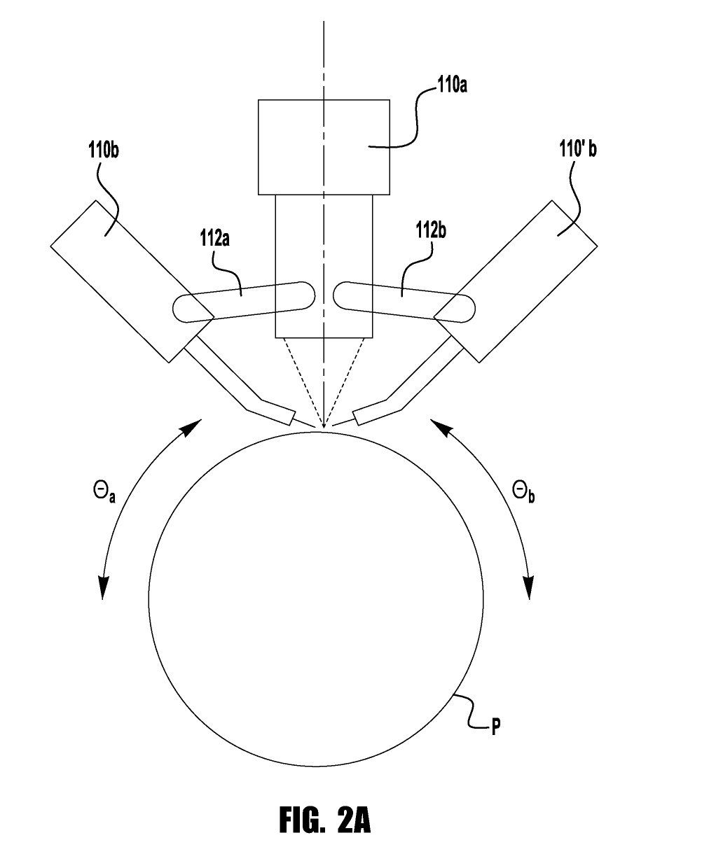

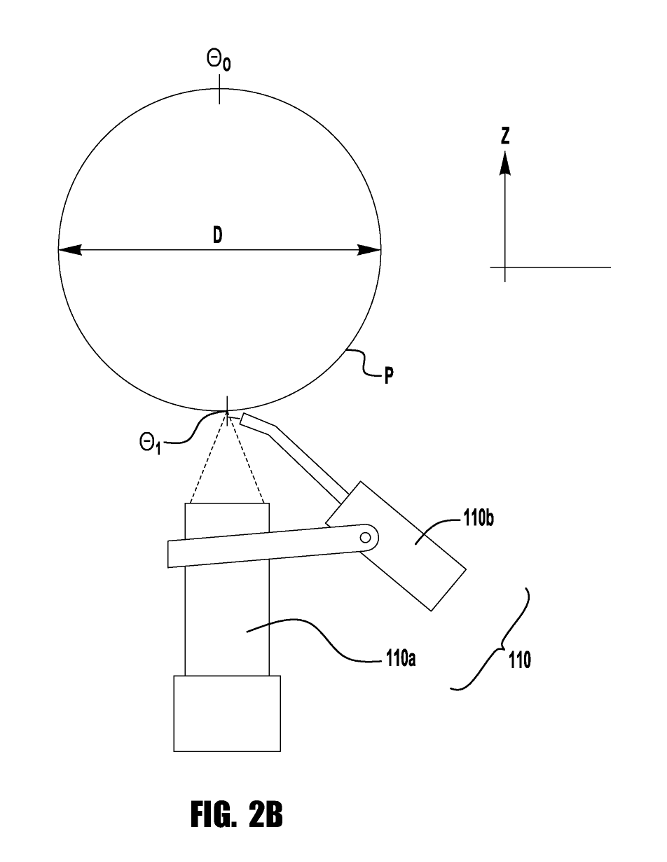

FIG. 2 shows an exemplary torch assembly 110 at an initial position θ₀ at the pipe end portion. The laser subassembly assembly 110a is coupled to the contact tube subassembly 110b by a bracket 112 to affect a filler wire-to-beam axis Z-Z defining an angle α, which ranges in one aspect from 15 to 80 degrees when measured as shown. However, if the angle is to be measured from the surface tangent of the pipe—at the point of the operation—then the angle is in the range of 10 to 75. In another aspect of the invention, the angle α is in the range of 15 to 45 degrees (or 45 to 75 degrees if measured from the tangent). It should be noted that the angle utilized can depend on various parameters including the size of the wire, the rotational speed of the operation, the size of the pipe, etc. Exemplary embodiments of the present invention can use various structures and methods to maintain the general arrangement of the torch assembly 110. The torch assembly 110, as described in greater detail below, is configured for carrying out a hot wire process in an orbital or circumferential rotation about a pipe P or other workpiece.

The laser optics assembly in one embodiment is a substantially a cylindrical member having a distal end 114a from which a collimated and focused laser beam exits and a proximal end 114b coupled to a laser beam delivery device such as for example, a fiber optic cable 111, as seen for example in FIG. 1A, coupled to a laser source 113. Exemplary embodiments of the laser source 113 includes CO2, Nd:YAG; YB Fiber, Yb Disk, or Direct Diode Disc for providing a wavelength from about 1 micron to about 11 microns and more particularly 0.8 microns to about 10.6 microns. It is also noted that the diodes (of a laser utilizing diodes) can be located at or near the pipe, or can be remote from the part with the energy delivered by a fiber. The contact tube subassembly 110b includes a distal end 116a from which the filler wire exits and a proximal end 116b, which in one aspect, connected to the power supply 115 to heat the filler wire for the hot wire process. In one aspect, the laser optics and contact tube subassemblies 110a, 110b are coupled together by the bracket 112 so as to minimize the clearance distance C between the distal end 114a of the laser optics subassembly and the distal end 116a of the contact tube subassembly. In one exemplary embodiment, the laser source 113 provides a power density of about 500 W/cm². The minimum clearance distance C preferably defines the minimum distance between the laser optics and the heated wire W at the pipe surface P sufficient to minimize or eliminate damage to the laser optics subassembly from heat yet sufficient to deliver the requisite laser energy the surface of the pipe P. Generally, in a representative embodiment of the present invention the laser optics subassembly 110a, as seen in FIG. 1C includes with two lenses: a collimating lens 108a and a focus lens 108b which are spaced apart at a distance zz from one another to form a laser beam having a particular size (spot size) and energy at the pipe surface. It is noted while this figure shows transmissive optics, other types of optics, such as reflective, scanning or cylindrical can be used. Referring again to FIG. 2, the clearance distance C in one aspect is a function of the size and axial spacing zz of the laser optics of the subassembly 110a. Accordingly, a desired minimum clearance C distance could be used to determine the laser optics configuration needed to deliver sufficient energy at the pipe surface for carrying out the hot wire process.

In addition to or in the alternative, the lenses are minimized and their spacing zz minimized so as to minimize the clearance distance C and further minimize the overall size of the laser optics subassembly 110a. With the size of the laser optics subassembly reduced the radial extension H over the torch assembly 110 may also be minimized. Reduction of the torch assembly 110 can reduce the drive and gearing requirements of the carriage 130 and track 120. Further in addition to or in the alternative, the housing of the laser optics subassembly 110a may be constructed to properly heat shield and protect the internal components of the subassembly to mitigate the impact of the heating process on the subassembly 110a such that the clearance distance C can be minimized.

In another aspect, the heat and inadvertent arcing from the filler wire W can be minimized or reduced to mitigate the impact of the heating process on the laser optics subassembly 110a such that the clearance distance C can be minimized. In one particular embodiment, the power supply 115 heating the filler wire W may be processed control to reduce the heat, arcing and/or inadvertent spattering so as to mitigate the impact of the process on the laser optics subassembly 110a. Described in greater detail below is an exemplary embodiment of a control system for the hot wire process and system 100.

The clearance distance C and/or size of the torch assembly 110 may be a function of the diameter of the track to which the torch assembly 110 is coupled. More specifically, the diameter of the track 120 may be defined by the nominal size of the pipe P to be processed. Referring to FIG. 2, if the torch assembly 110 is more particularly configured for a hot wire process over a range of nominal pipe size D. The laser optics subassembly 110a in one aspect is accordingly sized to hot wire process the largest nominal diameter size.

In operation, the carriage 130 and track 120 translates the torch assembly 110a an angular distance θ to clad the outer surface of the pipe P. In one aspect, the drive of the carriage may be configured to translate clock-wise or counter-clock-wise about the pipe P. In some embodiments, the carriage performs cladding for a pass in the clockwise direction, and then upon completion of that pass moves the head assembly along the pipe P by one bead width and then performs the next pass in a counter-clockwise direction. Thus, the carriage (and any cabling, etc.) unwinds itself with respect to the pipe P. In some exemplary embodiments, the transition from one pass to the next occurs at a different angular position during the cladding operation to ensure that not adjacent transitions are at the same angular position on the surface of the pipe. For example, for a first pass the cladding switches from the first pass to a second pass at an angular position of 180 degrees, then switches between the second and third passes at 0 degrees, then switches from the third and fourth passes at 185 degrees, and switches between the fourth and fifth passes at 5 degrees. In exemplary embodiments of the present invention, there are at least 2 angular degrees between any adjacent passes.

The contact tube subassembly 110b and filler wire W may therefore lead or follow the laser beam of the laser optics subassembly 110a about the outer surface of the pipe P. Alternatively or in addition to, the torch assembly 110 may include a second contact tube subassembly 110′b, as seen in FIG. 2A associated with a second filler wire spool and separate feed mechanism configured as the wire feeder 140. Thus, the dual contact tube subassembly 110b, 110′b provides for a filler wire leading the laser beam in each of the clock-wise or counter-clock-wise directions about the pipe P. As shown, the assembly can rotate in either direction θₐ or θ_{b} to add the cladding layer on the pipe.

Referring to FIGS. 2 and 2B, the torch assembly 110 is shown at an initial angular position θ₀. In operation, the torch assembly 110 is translated from its first position θ₀ at zero angle to a second position θ₁, for example 180 degrees from the first position θ₀. In traversing from the first position θ₀ to the second position θ₁, a hot wire process is carried out to clad a layer of material at the pipe end portion. In translation, the orientation of the torch assembly varies with respect to a pipe axis X-X. In some exemplary embodiments, the assembly 110 can be rotated around the pipe 360 degrees, while in other embodiments the assembly 110 rotates 180 degrees in a first direction, returns to its start point and 180 degrees in the other direction. Accordingly, the input signals to each of the laser optics subassembly 110a and contact tube subassembly 110b may need to be varied and controlled in order to maintain the hot wire process to maintain the desired cladding parameters.

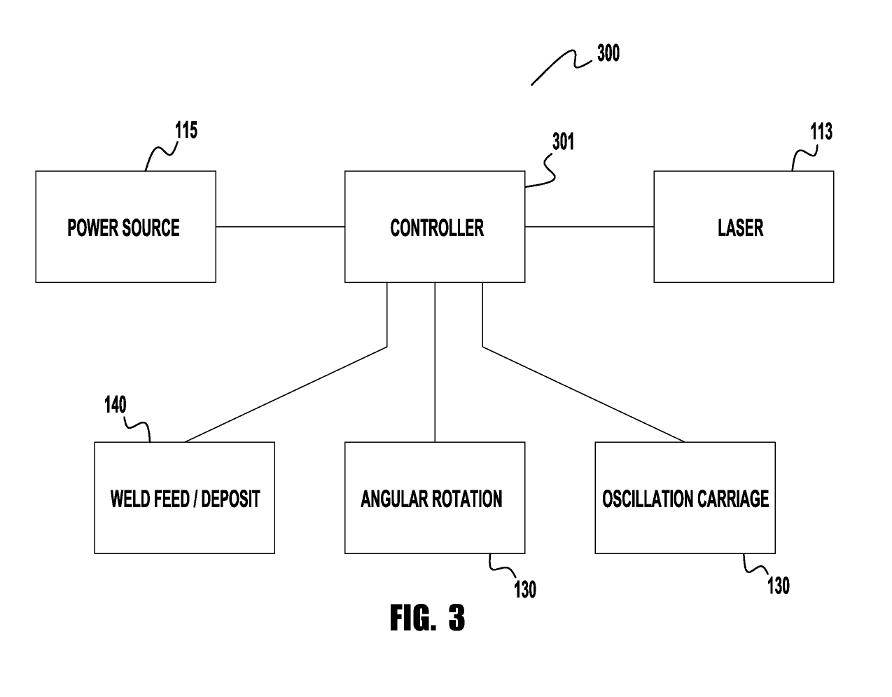

Shown in FIG. 3 is a control system 300 using a centralized controller 301 for maintaining the hot wire process using a torch assembly 110 rotated about the workpiece by an orbital translator. The controller 301 is coupled to each of the laser 113, hot wire power supply 115, wire feeder 140 and carriage 130 to provide the desired movement and process control. Various types of computer control systems can be used. For example, the hot wire process of embodiments of the present invention is controlled and operated similar to that described in U.S. Publication No. 2011/0297658, published on Dec. 8, 2011, the entire disclosure of which is incorporated herein by reference.

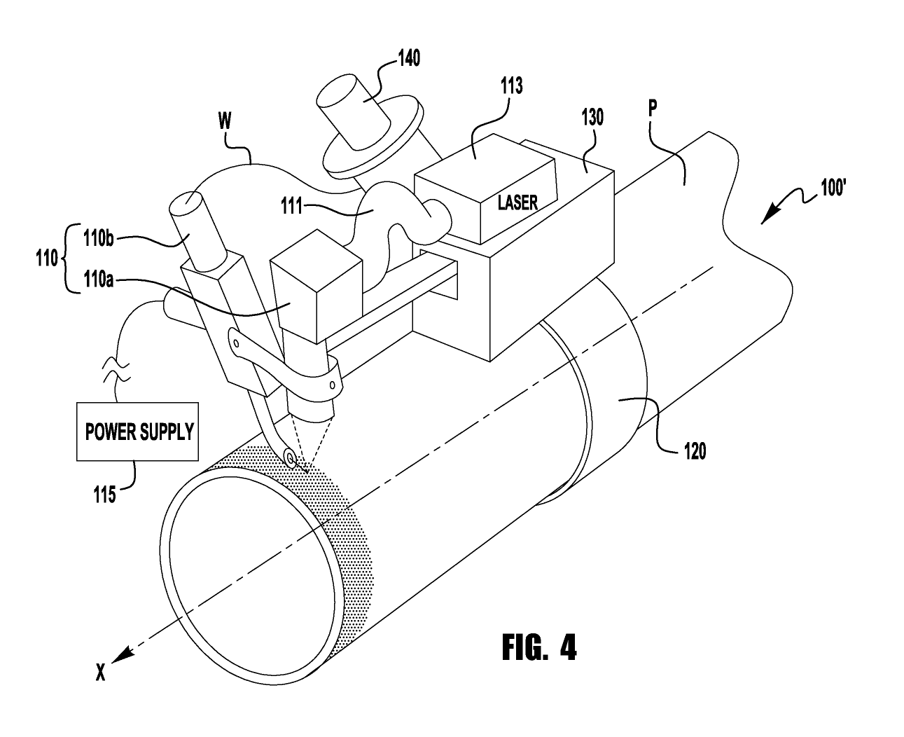

In addition to the control arrangements to carry out an orbital hot wire welding operation, the wire feed and cabling connected to the rotating torch assembly 110 should be configured so as not to interfere with the rotating components of the system. For example, the power supply cable 117 to the contact tube assembly 110b should be configured so as to avoid entanglement with the orbital welding equipment. Moreover, the laser optics subassembly 110a in one embodiment has a fiber optic cable 111 coupled to it for delivery of the laser beam from the laser source. The fiber optic cable 111 should be arranged so as avoid entanglement with the orbital welding equipment. In addition, the fiber optic cable 111 should be configured so as not to degrade the laser signal to the optics. Shown in FIG. 4 is an alternate arrangement of the system 100′ so as to reduce the fiber optic cable coupled to the laser optic subassembly 110a. More specifically the laser source 113 is mounted to the carriage 130 so as to rotate about the pipe P with the torch assembly 110. With the laser source 113 mounted to the carriage 130, the fiber optic cable 111 is minimized so as to reduce interference with the rotating system.

It should be noted that in many of the embodiments discussed above—which are intended to be exemplary in nature—the pipe remains stationary while the carriage assembly is rotated. Of course, in other exemplary embodiments, the pipe P can be rotated. Further, embodiments of the present invention are not limited to embodiments which clad the outer diameters of pipes, but can also be utilized to clad the inner diameters of pipes.

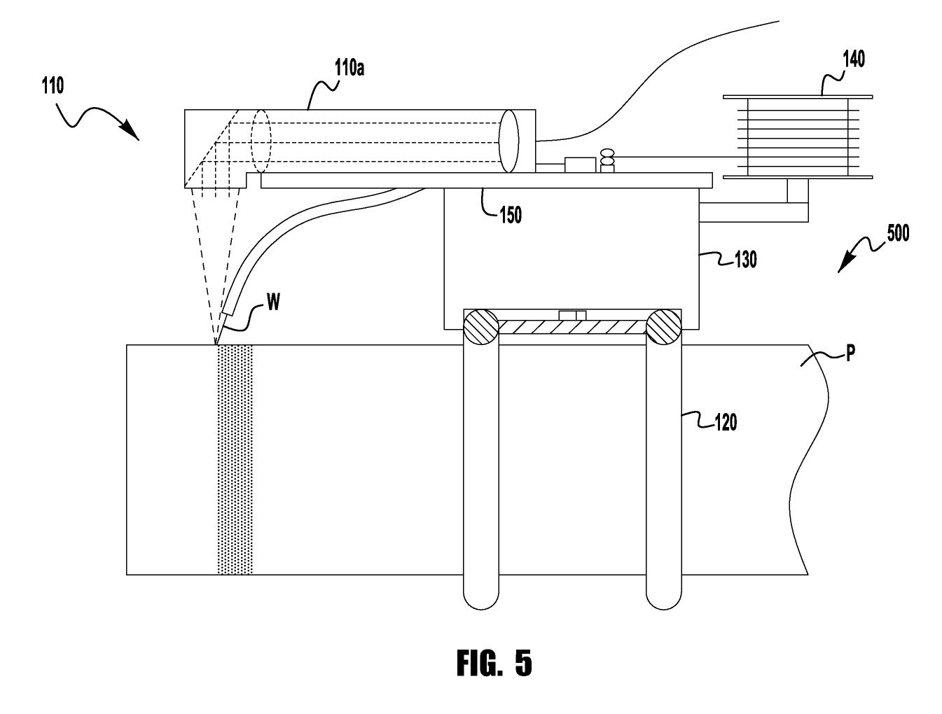

FIG. 5 depicts another exemplary embodiment of the present invention, where the system 500 uses a laser assembly 110 which has a right angle configuration as shown. The general operation and utilization of such a system is similar to that described above. However, such embodiments can be utilized when manufacturing or space requirements dictate the need for a shorter overall height to the system 500. Thus, the assembly 110 can utilize optics to direct the beam to the pipe surface but allow the optics subassembly 110a to be oriented such that it is closer to the pipe. This will allow for efficient height management, and can be especially useful fro cladding an inner surface of pipes.

It should also be noted that even though the above description has utilized discussion of a typical round consumable or wire, embodiments of the present invention can also be used with a strip type consumable (having a generally rectangular cross-section) which can utilize linear or scanned optics to aid in the creation of the puddle, as described herein.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

We claim:

1. A pipe cladding system; comprising:
a high intensity energy source which creates a molten puddle on a surface of a pipe;
a hot wire heating system which creates a heating signal to heat at least one filler wire such that said filler wire melts in said molten puddle when said filler wire is in contact with said puddle, where said hot wire heating system sets a threshold value for said heating signal which is below an arc generation value and monitors a feedback from said hot wire heating signal and said hot wire heating system turns off said heating signal when said threshold value is reached such that no arc is generated between said filler wire and said puddle, and where after said heating signal is turned off said heating signal is turned back on to continue cladding said pipe, where said hot wire heating system comprises a torch assembly which delivers said heating signal to said filler wire;
a wire feeding system which advances said filler wire to said puddle; and
a carriage assembly which is mountable to a pipe and which is rotatable about said pipe, wherein each of said high intensity energy source and said torch assembly is mounted to said carriage assembly so as to be moved with said carriage assembly.

2. The system of claim 1, wherein said torch assembly is oriented such that said filler wire is directed at said puddle at an angle in the range of 15 to 80 degrees relative to a normal of a surface of said pipe while said carriage assembly rotates about said pipe.

3. The system of claim 1, wherein said carriage assembly is rotatable in both a clockwise and counterclockwise direction.

4. The system of claim 1, wherein said high intensity energy source is a laser directing a beam at said pipe.

5. The system of claim 1, wherein said torch assembly is oriented such that said filler wire is directed at said puddle at an angle in the range of 15 to 45 degrees relative to a normal of a surface of said pipe while said carriage assembly rotates about said pipe.

6. The system of claim 1, wherein said carriage assembly is rotatable up to 180 degrees around said pipe.

7. The system of claim 1, wherein said carriage assembly is rotatable up to 360 degrees around said pipe.

8. The system of claim 1, wherein said carriage assembly comprises a translation mechanism which translates at least one of said high intensity energy source and said torch assembly in a lengthwise direction relative to said pipe.

9. A method of pipe cladding; comprising:
creating a molten puddle on a surface of a pipe with a high intensity energy source;
generating a heating signal from a hot wire heating system and directing said heating signal to a torch assembly which delivers said heating signal to at least one filler wire to heat said filler wire such that said filler wire melts in said molten puddle when said filler wire is in contact with said puddle;
setting a threshold value for said heating signal which is below an arc generation value and monitoring a feedback from said hot wire heating signal;
turning off said heating signal when said threshold value is reached such that no arc is generated between said filler wire and said puddle, and after said heating signal is turned off said heating signal is turned back on to continue cladding said pipe;
advancing said filler wire to said puddle; and
rotating a carriage assembly relative to said pipe, where each of said high intensity energy source and said torch assembly is mounted to said carriage assembly so as to be moved with said carriage assembly.

10. The method of claim 9, further comprising directing said filler wire at said puddle at an angle in the range of 15 to 80 degrees relative to a normal of a surface of said pipe while said carriage assembly rotates about said pipe.

11. The method of claim 9, wherein said rotating of said carriage assembly occurs in both a clockwise and counterclockwise direction relative to said pipe during said cladding.

12. The method of claim 9, wherein said high intensity energy source is a laser directing a beam at said pipe.

13. The method of claim 9, further comprising directing said filler wire at said puddle at an angle in the range of 15 to 45 degrees relative to a normal of a surface of said pipe while said carriage assembly rotates about said pipe.

14. The method of claim 9, wherein said carriage assembly is rotatable up to 180 degrees around said pipe.

15. The method of claim 9, wherein said carriage assembly is rotatable up to 360 degrees around said pipe.

16. The method of claim 9, further comprising translating said carriage assembly in a lengthwise direction relative to said pipe during said cladding.

17. The method of claim 9, further comprising, during said cladding, rotating said carriage assembly in a first rotational direction for a first amount of angular degrees; translating said carriage assembly in a linear direction to said pipe and rotating said carriage assembly in a second rotational direction for said first amount of angular degrees; translating said carriage assembly in said linear direction; rotating said carriage assembly for a second amount of angular degrees, which is different than said first amount of angular degrees; and rotating said carriage assembly in said second rotational direction for said first amount of angular degrees.

18. The method of claim 17, wherein the difference between said first angular degrees and said second angular degrees is at least 2 degrees.
